(19) United States
(12) Patent Application Publication
(10) Pub. No.: US 2015/0367932 A1
(43) Pub. Date: Dec. 24, 2015

(54) Delta M-Wing Unmanned Aerial Vehicle

(71) Applicant: Dillon Mehul Patel, San Diego, CA (US)

(72) Inventor: Dillon Mehul Patel, San Diego, CA (US)

(73) Assignee: Dillon Mehul Patel, San Diego, CA (US)

(21) Appl. No.: 14/046,927

(22) Filed: Oct. 5, 2013

(51) Int. Cl. B64C 3/10; B64C 25/10; B64C 39/02

(52) U.S. Cl. CPC B64C 3/10; B64C 39/024; B64C 25/10; B64C 2201/021

(57) ABSTRACT

An aerial vehicle compromising of a streamline delta wing structure, an M-wing structure accomplished through dihedral and dropped wing tips, and a variable incidence tail. The structure of the vehicle produces high lift and drag while maintaining stability and control at high angles of attack.

### BACKGROUND OF THE INVENTION

This invention relates to achieving a controlled spot-landing of unmanned aerial vehicles through the perched landing maneuver. Specifically, it relates to the design of the aircraft which allows the vehicle to accomplish the perching maneuver through spot landing methods.

The perched landing maneuver allows a fixed-wing aircraft to land on a specified point with minimal horizontal and vertical velocity. This permits the vehicle to safely land in adverse terrain, while additionally providing an alternative pathway to loitering above a specified target for long durations of time. This highlights one current shortcoming in the unmanned sector of the aerospace field, as this novel design decreases the energy expenditure and detection rate of the aircraft through its landing capabilities. Another shortcoming in the current field is that the designs of unmanned aerial vehicles do not produce enough lift and drag to accomplish this maneuver. In addition, the designs lack stability and control as well as alternate pathways compared to the current landing solutions.

### SUMMARY OF THE INVENTION

The present invention of the Delta M-wing aircraft with a variable incidence tail overcomes the shortcomings of the current unmanned aerial vehicles by allowing the fixed wing aircraft to spot land with minimal energy expenditure and a large degree of freedom.

It is an object of the invention to create a high lift and drag as the angle of attack of the design increases. It is another object of the invention to increase the stability of the aircraft during both horizontal flight as well as high angles of attack through the M-Wing design, exhibited through the dropped wing tips and wing dihedral. The perched landing maneuver is initiated with the variable incidence tail at a specified angle, creating a large increase in the angle of attack and subsequently the lift and drag associated. The fixed wing design also allows the aircraft a larger degree of freedom when landing, compared to the current landing methods. It is still another object of the invention to decrease the detection rate of the aircraft through the fixed-wing, biomimetic design with a variable incidence tail. Another object of the invention is the high structural integrity to absorb remaining landing energy as well as house electrical and landing components. After landing, it is an object of the invention to have ease of redeployment without any outside intervention. Preliminary computer simulation and wind tunnel testing verify the aerodynamic and structural elements of the design.

### BRIEF DESCRIPTION OF DRAWINGS

FIG. 1 is a perspective view of a Delta M-Wing Micro Air Vehicle illustrating the invention

FIG. 2 is a top view of the aircraft depicted in FIG. 1

FIG. 3 is a front view of the aircraft depicted in FIG. 1

FIG. 4 is a left side view of the aircraft depicted in FIG. 1

FIG. 5 is a top view of an aircraft with a propeller for propulsion

FIG. 6 is a front view of an aircraft with a propeller for propulsion

FIG. 7 is a top view of an aircraft with alternate vertical thrust

FIG. 8 is a front view of the left wing of the aircraft depicted in FIG. 1

FIG. 9 is the top view of the left wing of the aircraft depicted in FIG. 1

FIG. 10 is the side view of the left wing of the aircraft depicted in FIG. 1

FIG. 11 is the top view of the left wing tip of the aircraft depicted in FIG. 1

FIG. 12 is the side view of the left wing tip of the aircraft depicted in FIG. 1

FIG. 13 is the front view of the left wing tip of the aircraft depicted in FIG. 1

FIG. 14 is the top view of the fuselage of the aircraft depicted in FIG. 1

FIG. 15 is the front view of the fuselage of the aircraft depicted in FIG. 1

FIG. 16 is the side view of the fuselage of the aircraft depicted in FIG. 1

FIG. 17 is the top view of the tail of the aircraft depicted in FIG. 1

FIG. 18 is the front view of the tail of the aircraft depicted in FIG. 1

FIG. 19 is the side view of the tail of the aircraft depicted in FIG. 1

### DETAILED DESCRIPTION OF THE PREFERRED EMBODIMENT

The detailed description of the invention that follows is provided for explanatory purposes, and the whole of the description is provided for an illustrative and not limitative sense. The language used is known to those competent in the art. The extent of the present invention is solely limited to the scope of the claims that follow.

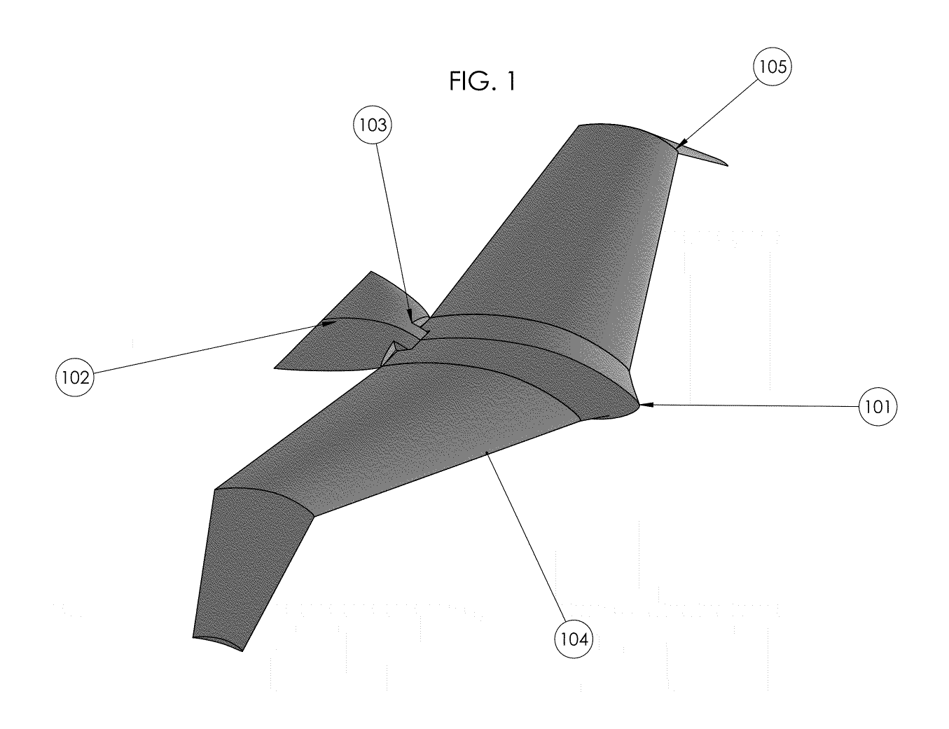

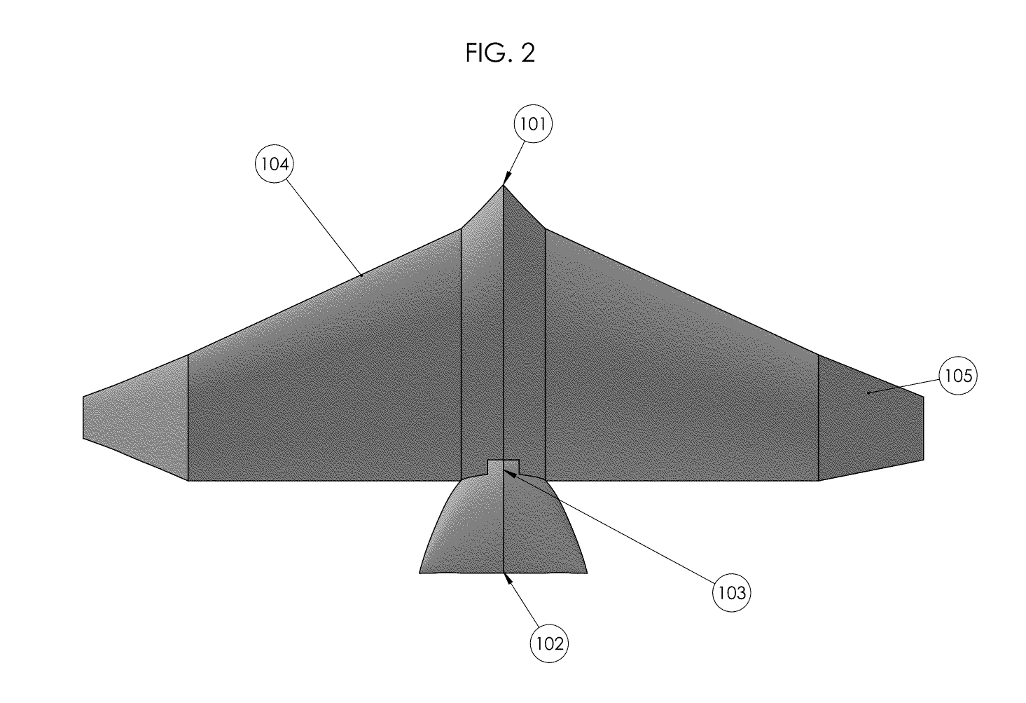

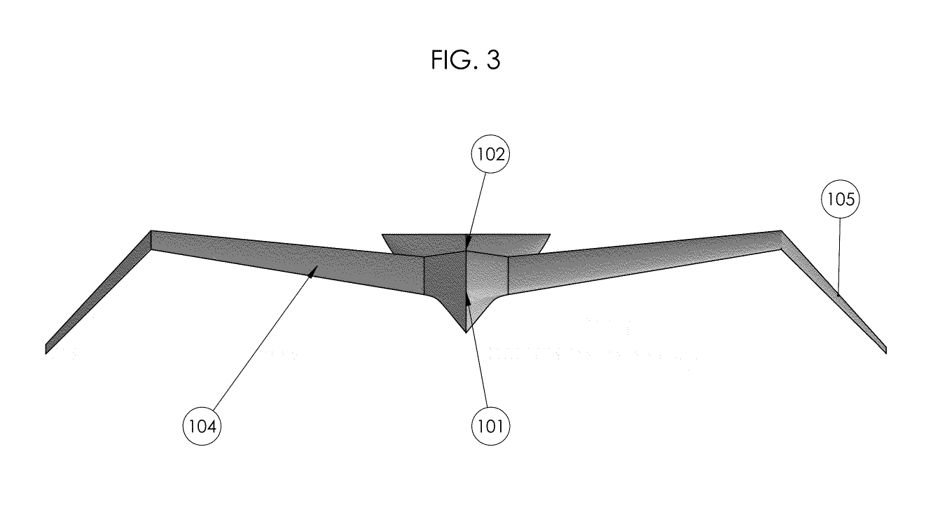

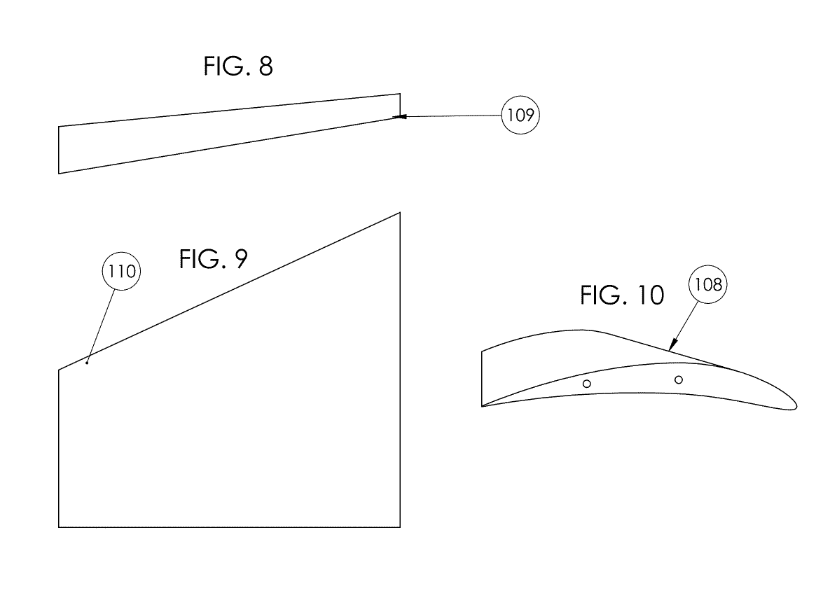

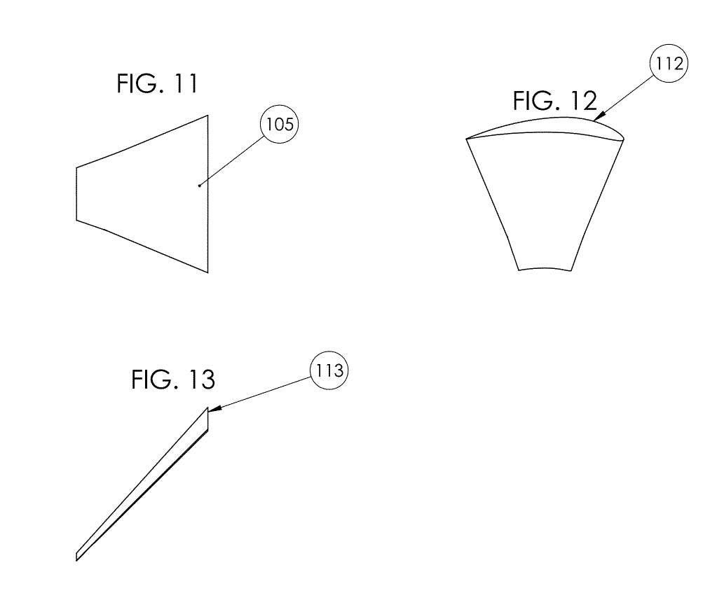

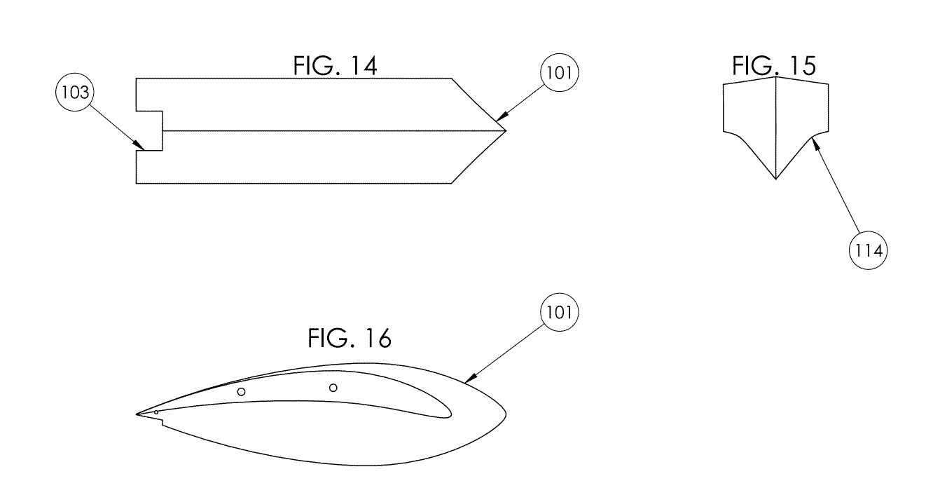

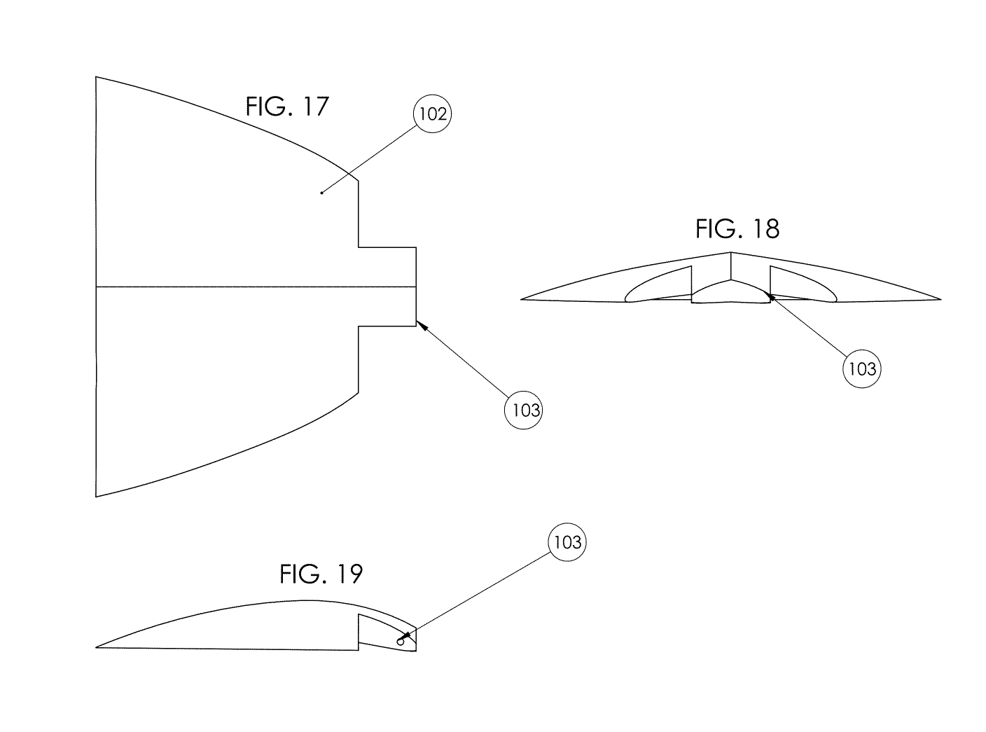

One aspect of the present invention, depicted in FIG. 1, shows the structural airframe of a streamline fixed-wing unmanned aircraft. The central member 101 consists of a symmetrical teardrop shape tapered into the airfoil shape 114 of the symmetrical wing members 104. The bases of lifting members 108 depicted in FIG. 10, conjoined at the tapered edges of member 101, are extruded and taper into the members 105. The offset of origin members 104 and edge of members 105 creates the “delta” shape of FIG. 2 and FIG. 9. Relevant angles for the offset in the negative direction are from −1° to −60°, as shown in FIG. 8 and member 109. Members 104 have an upward angling from 1° to 40°, or dihedral, and are mated with members 105 at member 112 which are angled downward from −1° to −90° depicted in FIG. 113 to create dropped wing tips. Members 104 and 105 are mated together to create the “M” wing shape exhibited in FIG. 3 and more closely in FIG. 8.

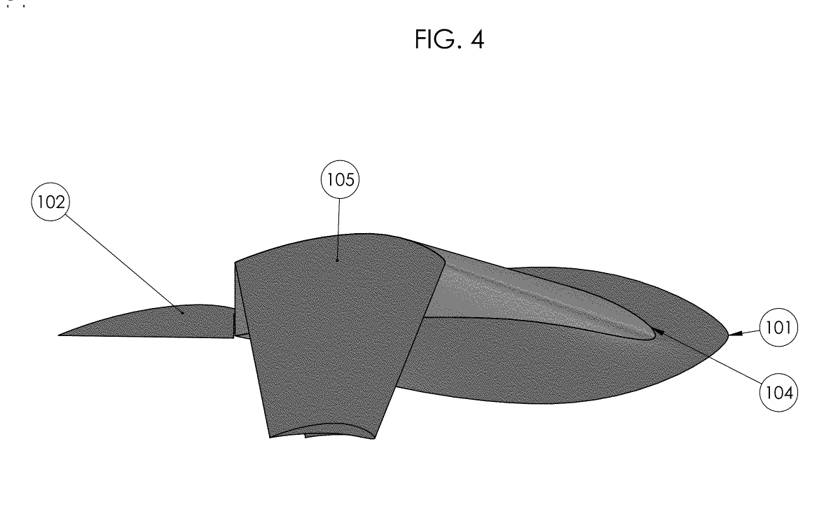

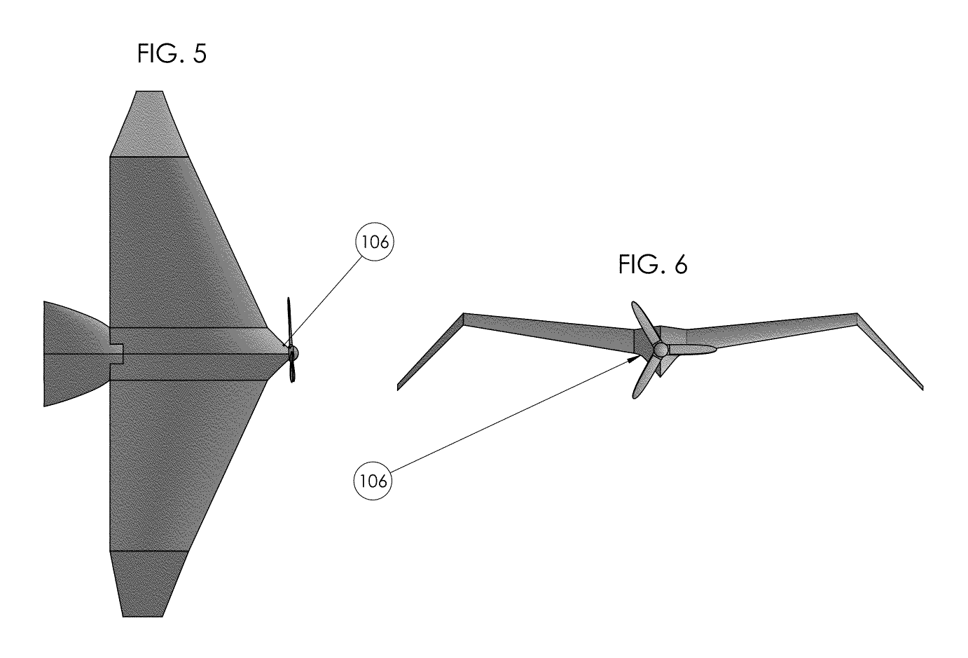

Member 101 is conjoined to member 102 by the joint 103. Member 102 has a symmetrical arch-like structure, as exhibited in FIG. 2. 102 tapers into a sharp trailing edge, exhibited in FIG. 4. The center of member 102 is tapered into the edges of the arch-like structure. Member 102 may be substituted for a body extruding from member 101 for the purpose of controlling the aircraft during flight or initiating the landing maneuver. Member 102, more closely viewed in FIG. 17, has a symmetrical extrusion 103 cut from member 102. This extrusion mates with the socket of member 101. Member 103 is connected to member 102 and 101 by at least one perpendicular connector. This allows member 102 to rotate on the vertical axis from 90° to −90° with minimal friction and no interference between members 103 and 101. The perpendicular connector is fixed with at least servo mechanism to create a vertical load to rotate 102 in an upward or downward direction.

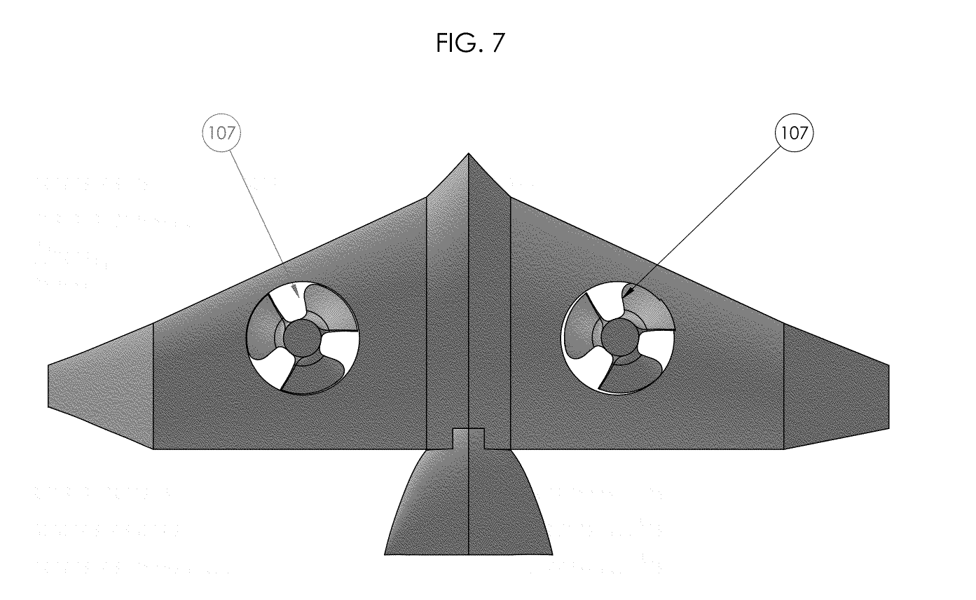

Referring now to FIG. 6, member 101 may be fitted with a propulsion unit to provide the aircraft with velocity in the forward direction. As used herein, the vehicle is fitted with a 3-prong propeller 106; however, any propulsion system may be used. Electrical component housing may be fitted in member 101, including a power unit, control avionics, and vehicle control system sensors. Members 101 or 104 may also include a landing gear mechanism which deploys landing gear, including but not limited to wheels or extended arms to latch onto the desired landing target. As pictured in FIG. 7, vertical propulsion systems 107 may be fitted into members 104 to provide assistance in takeoff and landing procedures or during horizontal or vertical flight.

Although the fabrication of this design may include various foams and composites, the preferred fabrication method includes a foam core layered with composite material. Additionally, fabrication of the joints between members 101 and 104, 104 and 105, 102 and 103, 101 and 103, may include composite additions to the binding sites to aid the structural integrity of the joints and to absorb additional landing energy.

The following claims of the present invention define the scope of the invention, though numerous changes and modifications may be made without departing from the extent of the invention.

1. A M-wing aerial vehicle comprising of:
a) An Unmanned Aerial System
i) An M-wing structure wherein dihedral members are placed an upward angling from 1° to 40° and wing tip members are placed at a downward angling from −1° to −90°
ii) A delta wing structure wherein the members are offset in the negative direction are from −1° to −60°
iii) A vehicle embodying a variable incidence tail
iv) A propeller driven aircraft
a) A vehicle embodying a vertical propeller system
b) A vehicle embodying a horizontal propeller system
c) A propeller propulsion system combining vertical and horizontal propulsion
v) Retractable landing gear
a) Retractable landing gear stowed into the wings
b) Retractable landing gear stowed into the fuselage
c) Landing gear using latching capabilities
vi) A vehicle comprising of control avionic and vehicle control system sensor additions
vii) A vehicle composed of a composite frame
a) A vehicle wherein the structure comprised of a foam core
b) A vehicle wherein the frame binding sites include composite additions
